(19) United States
(12) Patent Application Publication
(10) Pub. No.: US 2015/0028049 A1
(43) Pub. Date: Jan. 29, 2015

(54) ASSEMBLY ASSEMBLED OF A RECIPIENT AND A RETAINER, A METHOD FOR PRODUCING THE ASSEMBLY, AND A USE OF THE ASSEMBLY

(71) Applicant: ALL IN ONE BAG APS, HOLTE (DK)

(72) Inventor: Bjørn Karlo Larsen, Stenlose (DK)

(73) Assignee: ALL IN ONE BAG APS, HOLTE (DK)

(21) Appl. No.: 14/381,141

(22) PCT Filed: Feb. 26, 2013
(86) PCT No.: PCT/DK2013/050050

§ 371 Date: Aug. 26, 2014

(30) Foreign Application Priority Data
Feb. 27, 2012 (DK) PA 2012 00158

(51) Int. Cl. B65D 83/08; B31B 41/00; B31B 19/26

(52) U.S. Cl. CPC B65D 83/0805; B31B 19/26; B31B 41/00; B31B 2221/10
USPC 221/47; 493/210

(57) ABSTRACT

An assembly of a recipient for in a using state of the assembly receiving objects of different kinds and of a retainer for in a resting state of the assembly retaining the recipient. The retainer is formed as a case and the recipient is, before being assembled with the case, formed as a tube which has a first and second end part and in the resting state of the assembly has been folded up in a predetermined way into at least nearly parallel folds and, which are placed close to and/or are abutting each other. The assembly forms, when being in use, a desirable large bag for containing objects of different kinds and when not being in use a small case which is comfortable to store and handle.

An assembly assembled of a recipient and a retainer, a method for producing the assembly, and a use of the assembly

The invention relates to an assembly of a recipient for in a using state of the assembly receiving objects of different kinds and of a retainer for in a resting state of the assembly retaining the recipient.

The invention also relates to a method for producing the assembly and to a use of the assembly and of the method for producing the assembly.

Frequently are objects turning up of such kind, that it is necessary rapidly to put them into a safe packaging for thereby securely avoiding polluting of the surroundings and to keep them too in said packing until they can be disposed.

Such objects can among other things be for instance garbage of different kinds, napkins, sanitary towels and incontinence means.

Especially inexpensive bags are widely used for in an easy and comfortable way keeping objects of e.g. the above-mentioned kind safely isolated from the surroundings and to be disposed together with the bags.

Each bag need to have a sufficiently large size for being able to contain suitable portions of objects whereby storing of new bags can be a problem in itself.

Usually the bags therefore are marketed in form of rolls of long strips which each comprises a number of flat-laid bags separated from each other by transverse perforating lines.

In situations where a user requires a bag for being able to packing objects, the user needs to take a roll of bags out of a depository, unroll the roll at least partly, tearing off a bag from the rest of the bags in the roll along a perforating line, rolling up the roll again and replacing the roll in the depository.

It is self-evident that it is a slow process to get hold in a bag in such way and that it moreover is a tiresome and time-wasting work, which often need to be repeated more times a day.

And said operations is furthermore nearly impossible to perform when the user is out of the house, e.g. driving a car, so that he/her doesn't dispose of a store of bags.

An attempt to solve those problems is known from the U.S. Pat. No. 4,117,847 disclosing a shopping bag with a case attached to the inner side of the bag at the edge of its mouth.

The purpose of this arrangement is to reduce the volume of the shopping bag when not being used so that it will be more comfortable for the user to handle and store the bag. The reducing of the volume takes however place by in an accidentally way folding and rolling up the bag and putting the bag packed together in this way into the case which therefore need to have a relatively large volume.

Owing to the fact that the case is placed on the inside and not on the outside of the bag are those operations also difficult and troublesome to carry out.

The arrangement for reducing the volume of the bag reduces unfortunately also the use-value of the shopping bag because the case, which as mentioned is placed on the inner side of the bag, is occupying some of the compartment in the shopping bag and also more or less is in the way for articles being put into the bag via the mouth of this.

The position of the case inside the bag also causes that disadvantages that the bag only partly can be stored in the case and that some of the bag is exposed to external influences there, if occasion should arise, could damage the bag more or less even in its storing state.

This known assembly of a bag and case is adapted for alternatively being used as a shopping bag and to be packed up in the case for temporary being stored whereby said assembling need to have a relatively heavy and therefore expensive structure which is unfit for being used to e.g. an inexpensive disposable bag.

The Danish utility application BA 2011 00041 discloses an assembly of a bag for in a using state of the assembly receiving objects of different kinds and of a case for in a resting state of the assembly storing the bag.

The bag of this known assembly is in the resting state folded up in the case in an accidentally way causing the assembly of the bag and the case to be troublesome and uncertain and the case to get an undesired large size so that it can be able to contain the relatively large volume of the tube being packed up in the case in this way.

The above-mentioned disadvantages of the prior art assembly of a recipient for in an using state of the assembly receiving objects of different kinds and of a retainer for in a resting state of the assembly retaining the recipient are according to the invention remedied by,

in a first aspect of the invention providing an assembly of the kind mentioned in the opening paragraph which in the using state forms a suitable large compartment for containing objects and in the resting state is small enough to make the assembly easy and comfortable to store and handle,

in a second aspect of the invention providing an assembly of the kind mentioned in the opening paragraph which has a simple and inexpensive structure.

in a third aspect of the invention providing an assembly of the kind mentioned in the opening paragraph which easy and fast can be transformed from resting to using state,

in a fourth aspect of the invention providing an assembly of the kind mentioned in the opening paragraph in which the retainer is protecting the recipient against sustaining damage in the resting state of the assembly,

in a fifth aspect of the invention providing a method for assembling the assembly mentioned in the opening paragraph of a recipient adapted for in a using state of the assembly receiving objects of different kinds and of a retainer adapted for in a resting state of the assembly retaining the recipient,

in a sixth aspect of the invention providing a use of the assembly and of the method mentioned in the opening paragraph.

The novel and unique features whereby these and further aspects of the invention are achieved consists in the fact that the retainer is formed as a case and that the recipient, before being assembled with the case, is formed as a flexible tube which has a first and second end part and in the resting state of the assembly is folded up in a predetermined way in the case into at least nearly parallel folds, which are placed close to and/or are abutting each other.

The special way upon which the tube of the invention is folded up secures advantageously that the tube can be folded up into a very small size so that the case can be formed with a corresponding small size whereby the assembly in its resting state is easy and comfortable to store and handle and in the using state has a suitable large compartment for receiving the desired volume of objects.

In an expedient embodiment of the invention can the retainer moreover be formed as a case with an access opening into a cavity which has an area defined by a depth extending into a direction perpendicular to the access opening and a width extending into a direction perpendicular to the direction of the depth whereby the tube can have a larger area than said cavity.

The assembly of the tube and the case thus achieves a simple and inexpensive structure, which in the using state advantageously has a large capacity for containing objects and in the resting state has a very little volume.

In another embodiment of the invention can one of the folds of the tube be attached to the case while the other folds freely can be arranged in the case, and the second end part of the tube can simultaneously be formed with the mouth of the tube placed at the access opening of the case whereby is obtained that advantage that the bag safely is secured to the case and is ready also for quickly being pulled out of the case into the using position.

Said pulling operation can moreover be easy and safe to carry out when the second end part of the tube is equipped with one or more flaps protruding out of the case so that a user easily can catch said flaps with the fingers and thereby be able to comfortable and quickly pulling the tube out of the case.

In a variant of this embodiment can the flaps be present inside the case in the resting state of the assembly where the tube is folded up in the case, while a releasable cap covers the access opening of the case. The flaps thereby securely are protected against external influences in the resting state of the assembly.

When the access opening of the case has a length, which is smaller than the width of the case is advantageously achieved that the bag, when being present in the case in the resting state of the assembly, is secured against accidentally falling out of the case.

In a very advantageous embodiment of the invention can the tube in flat-laid state be folded along a first row of first folding lines, which are extending crosswise the end parts of the tube and are defining a first row of parallel first folds of which at least one has a width with about the same size as the width of the cavity of the case, and the first row of first folds can furthermore be folded along a second row of second folding lines, which are extending crosswise the first folding lines and are defining a second row of parallel second folds of which at least one has a width with about the same size as the depth of the cavity of the case.

By means of this particular folding method has the tube achieved the shape of a very compact packet of folds with a volume as little as possible whereby the case can be formed with a corresponding little volume so that the assembly of the invention is very handy to handle and store in the resting state of the assembly.

According to the invention can the tube be made of a foldable material and the case of a material, which is strong enough to protect the tube against being damaged by external influences.

Material for making the tube can according to the invention be plastic or paper and material for making the case can be plastic, paper, cardboard or metal.

The assembly of a recipient for in a using state of the assembly receiving objects of different kinds and of a retainer for in a resting state of the assembly retaining the recipient can in an expedient embodiment of the invention be produced by forming the recipient as a tube of a foldable material, flat-laying the tube, folding up the flat-laid tube in a predetermined way into parallel folds, which are placed close to each other or are abutting each other, and placing the tube in the retainer. In this way can the assembly advantageously be produced in a fast, simple and inexpensive way.

In one embodiment of the method can the tube be formed of a sheet of a flexible and foldable material by folding the sheet and welding or gluing the longitudinally extending edges of the sheet together and in another embodiment of the method can the tube be formed of two sheets of a flexible and foldable material and welding or gluing the longitudinally extending edges of the two sheets together. Both methods are fast and easy to utilize and the tube produced has a simple and inexpensive structure.

In a third embodiment of the invention can the tube be formed by extruding a hose of a foldable plastic with a relatively little wall-thickness and cutting the hose crosswise into pieces of the required lengths. This method is especially well suited for in a fast way producing large quantities of thin-walled tubes.

The assembly of the tube and the case and the method for making the assembly can according to the invention advantageously be used as a bag for containing a relatively large volume of objects even though the assembly can have a relatively little volume when not being used.

The invention will be explained in greater details below, giving further advantageous features and technical effects and showing also the successive operations steps of an exemplary embodiment with reference to the drawing, in which

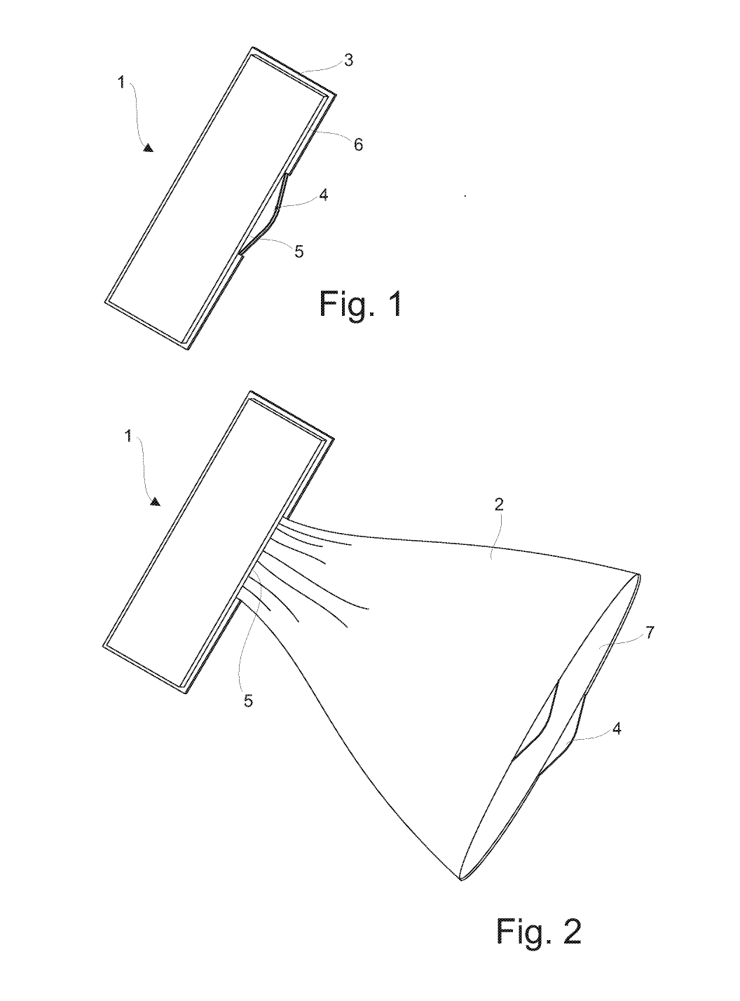

FIG. 1 is a perspective view, seen in the resting state of the assembly, which assembly according to the invention is assembled of a tube for in a using state receiving objects of different kinds and of a case for in a resting state storing the tube,

FIG. 2 shows the assembly, seen in the using state,

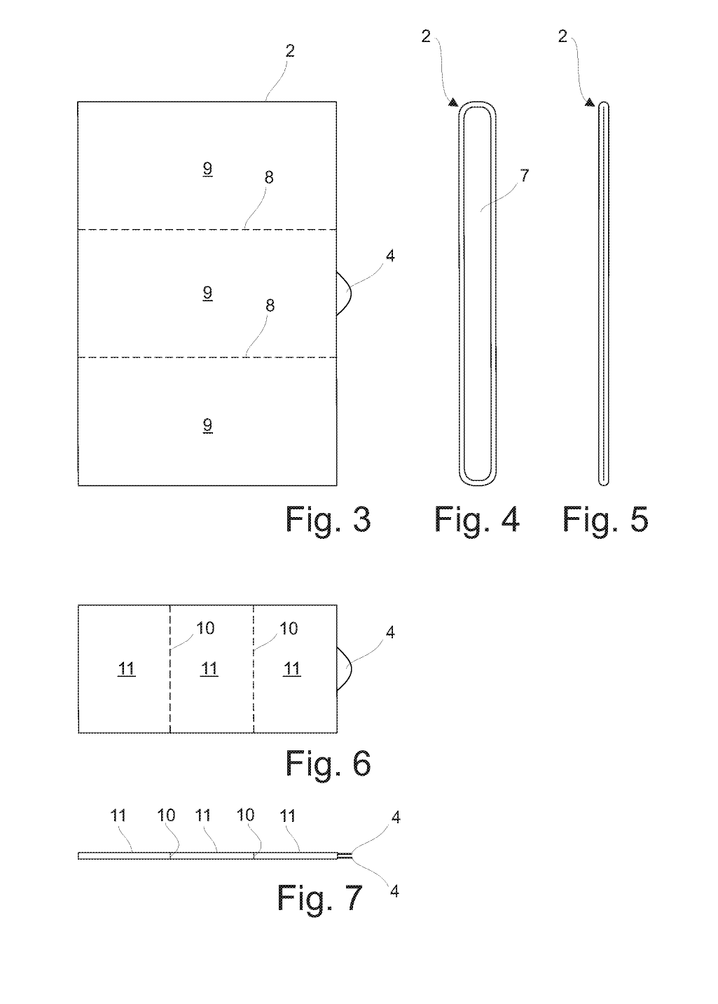

FIG. 3 shows, seen from the side, the tube of the assembly shown in FIGS. 1 and 2,

FIG. 4 is a cross-sectional view of the tube shown in FIG. 3,

FIG. 5 shows the same in a flat-laid state,

FIG. 6 shows, seen from the side, the tube shown in FIG. 3 folded up into first folds,

FIG. 7 shows the same, but seen from the edge side of the first folds,

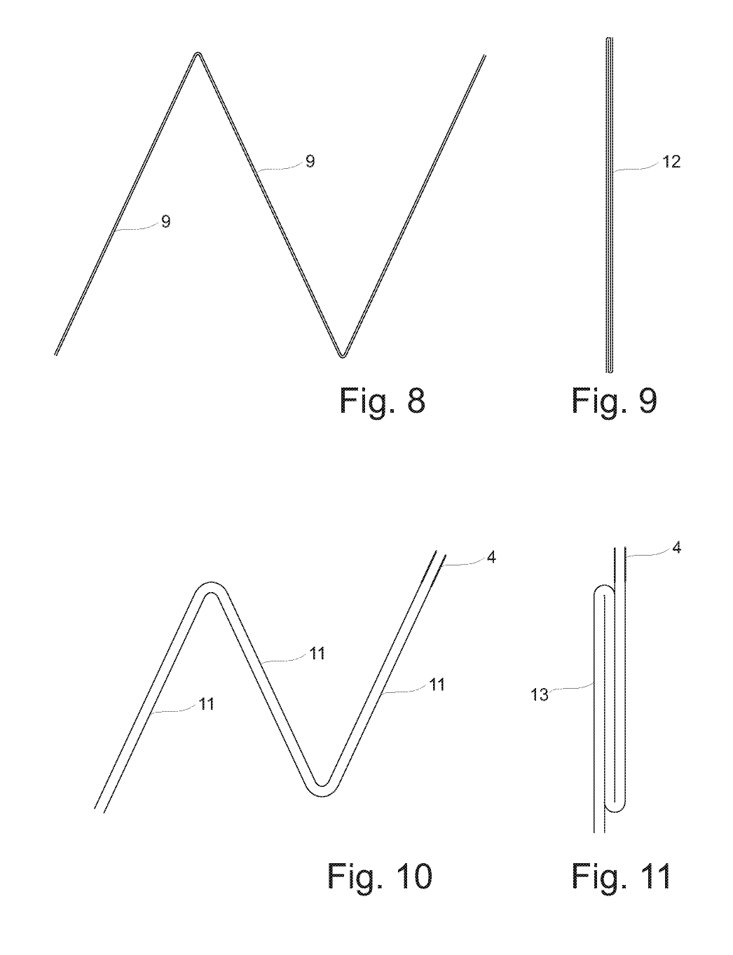

FIG. 8 shows in a larger scale a cross-sectional view of the first folds shown in FIG. 6 in an intermediate step,

FIG. 9 shows the same, but in a finished step,

FIG. 10 shows in a lager scale a cross-sectional view of the first folds shown in FIG. 9 folded up into second folds in an intermediate step,

FIG. 11 shows the same, but in a finished step,

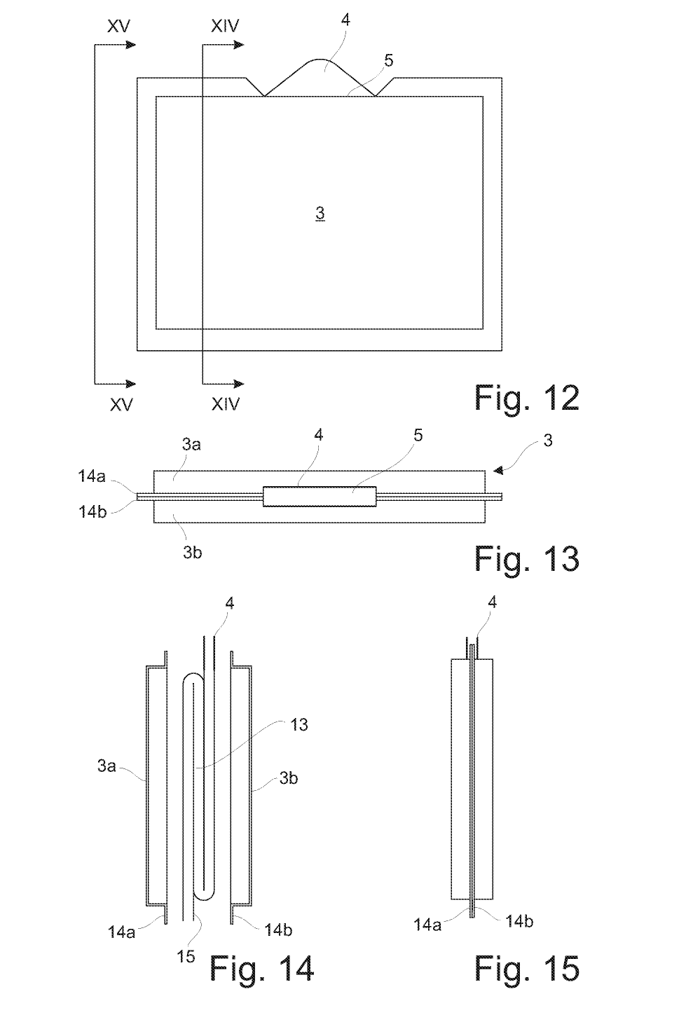

FIG. 12 shows the case, seen in FIG. 1, from the side,

FIG. 13 shows the same, but seen from the top,

FIG. 14 is a cross section of the case taken along the line XIV-XIV in FIG. 12, but before the assembling,

FIG. 15 shows the same in the assembled state seen into the direction XV-XV in FIG. 12,

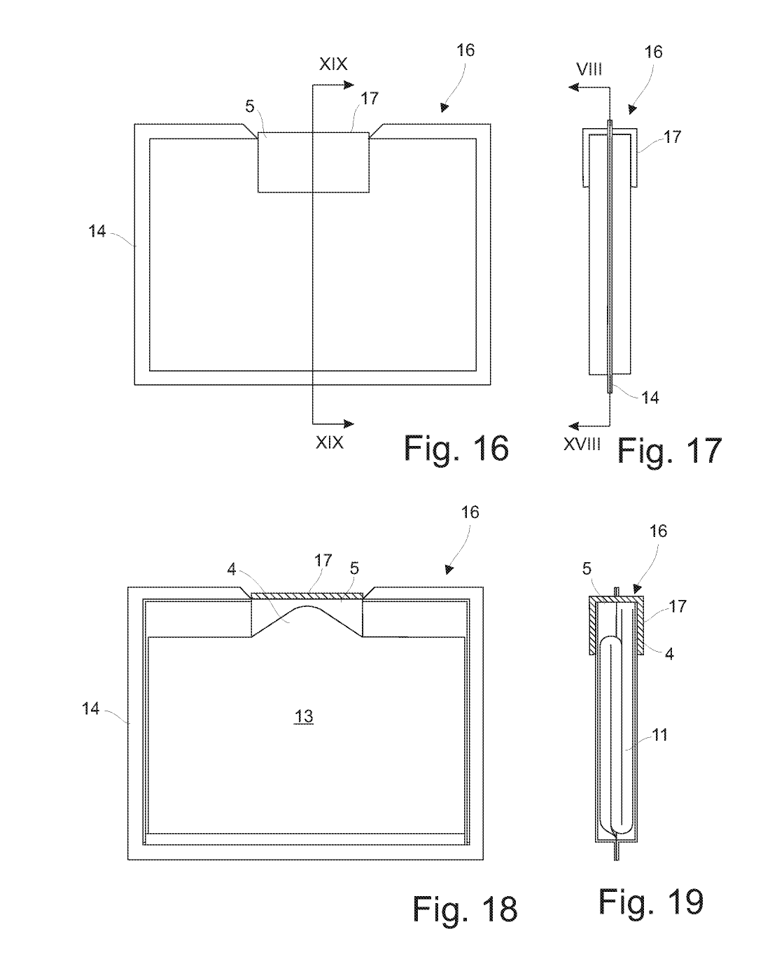

FIG. 16 shows, seen from the side, a variant of the case shown in FIG. 12,

FIG. 17 is a lateral view of the case shown in FIG. 16,

FIG. 18 is a cross section of the case taken along the line XVIII-XVIII in FIG. 17, and

FIG. 19 is a cross section of the case taken along the line XIX-XIX in FIG. 16.

The assembly of the invention is, as previously mentioned, assembled of a relative small and handy case for in a resting state storing a relatively large tube which in a using state is protruding out of the case so that the assembly can function as a bag being able to contain relatively large quantities of objects of different kinds, such as e.g. garbage.

FIG. 1 shows the assembly 1 in the resting state where the tube 2 is placed inside the case 3, and FIG. 2 shows the assembly in the using state where the tube 2—here only partly—has been pulled out of the case via an access opening 5, formed in a lateral edge 6 of the case, while a user (not seen) is holding two flaps 4, placed at the mouth 7 of the tube, with one hand (not seen) and the case with the other hand (not seen).

The tube can have one flap only or two or more flaps and each flap can be integral with the wall of the tube or be attached to this wall.

The little and handy case, which owing to its small size, can be stored nearly everywhere, for example in kitchens, handbags and coat pockets, can thus nearly instantaneously be transformed to a large and useful bag for, when needed, receiving and containing required quantities of objects of different kinds.

As mentioned above and seen also in FIGS. 1 and 2 is the tube 2 assembled with the case 1, but in FIG. 3 is the tube shown, seen from the side, before said assembling has been carried out.

FIG. 4 shows a cross-sectional view of the tube 2, which is made of a relative thin wall of a foldable material, e.g. plastic or paper.

FIG. 5 shows the tube in flat-laid state where two opposite halves of the wall of the tube is close to and/or is abutting each other.

Within the scope of the invention can the flat-laid tube be folded up into more sets of folds. The volume of the flat laid tube and thereby of the case too is advantageously decreased each time the tube is folded up once more.

In the present example is the flat-laid tube folded up into two sets of folds only, namely a first set of first folds 9 and a second set of second folds 11.

The first set of first folds 9 is achieved by along two first folding lines 8 folding up the tube, seen in FIG. 3, into three first folds 9.

The number of first folds 9 can however within the scope of the invention be another one than three, e.g. be between 2 and 10, preferable between 3 and 7.

The first set of first folds 9 are in FIG. 6 shown from the side and in FIG. 7 from the side of the edge. The flaps 4 are protruding from the right fold 11.

The second set of second folds 11 is achieved by along two second folding lines 10 folding up the first set of first folds 9 into three second folds 11.

The number of second folds 11 can however within the scope of the invention be another one than three, e.g. be between 2 and 20, preferable between 7 and 15.

FIG. 8 shows a cross section of the first folds 9 in an intermediate step and FIG. 9 shows the first folds folded up into a compact first packet 12 of parallel first folds 9 placed close to and/or abutting each other.

FIG. 10 shows a cross section of the second folds 11 in an intermediate step and FIG. 11 shows the second folds folded up into a compact second packet 13 of parallel second folds 11 placed close to and/or abutting each other.

Said second packet 13 is in this example also the final packet of the tube, which by being folded up in this way has been imparted so little a volume that the it can be placed in the cavity of the very little case 1.

The lower end of the left second fold 11 is attached to the case in the assembled state of the assembly and is therefore a little longer than the other second folds in dependence of how said attachment is carried out. The flaps 4 are placed at top of the right fold 11.

FIG. 12 shows the case 3 from the side and in FIG. 13 from the top. The flaps 4 are, as can be seen, protruding from the access opening 5 of the case 3.

As best seen in FIG. 13 consists the case 3 of two halves 3a and 3b with protruding flanges 14a and 14b. The two halves 3a and 3b of the case 3 has been interconnected by interconnecting the flanges 14a and 14b by means of e.g. pressure welding or gluing.

FIG. 14 is a cross section of the case 3 taken along the line XIV-XIV in FIG. 12, but showing the assembling of the final packet 13 of the tube 2 and the case 3 in an initial position.

In this initial assembling step are the two halves 3a and 3b of the case 3 placed at a distance from each other and upon each their side of the final packet 13 of the tube 2.

The lower part of the final packet is formed with an extension 15, which is connected to the flanges 14a and 14b simultaneously with that the flanges themselves have been interconnected in the way mentioned above.

The tube is thereby securely anchored in the case so that the case and the tube still stick together even if the tube is pulled out of the case as much as possible.

In another embodiment of the assembly can the final packet 13 of the tube 2 be placed in the case 3 without being connected to this so that the tube can be separated from the case when the assembly is being used, (not shown).

In FIG. 15, which is seen into the direction XV-XV in FIG. 12, has the two halves 3a and 3b of the case 3 been interconnected so that they now form the finished case 3 with the final packet 13 contained inside the case except of the flaps 4, which are protruding out of the access opening 5 of the case.

Within the scope of the invention can the case however be formed in other suitable ways than mentioned above and the assembling can take place also in other ways.

Deciding is that the large tube is folded up into a compact packet that can be placed in the small case.

FIGS. 16-19 shows a variant of the case corresponding at least in the main to the case 3 shown FIGS. 12-15. Same parts therefore are denoted same numerals.

In FIGS. 12-15 is the flap 4 protruding out of the access opening 5 of the case 3 in the resting state of the assembly while the flap 4 is placed inside the case in the variant of the case 16.

FIG. 16 shows the case 16 seen from the front side and FIG. 17 from the lateral edge side. The flaps 4 cannot be seen in these figures since a detachable cap 17, which in this example is U-formed, covers the access opening 5.

The assembly is in FIG. 16 and FIG. 17 seen in its resting state where the flaps 4 are present inside the case only so that the flaps securely are protected against external influences.

FIG. 18 is a cross section of the case 16 taken along the line XVIII-XVIII in FIG. 17 and FIG. 19 is a cross section of the case 16 taken along the line XIX-XIX in FIG. 16.

These figures show the final packet 13 of the folds 11 of the tube 2 with the flaps 4 placed inside the case 16. The flaps are in this example integral with the tube 2.

The cap 17 is removed when the assembly is going to be used as a bag whereby the access opening 5 in the case 16 is exposed so that the user (not seen) can get hold in the flaps 4 with the fingers (not seen) and pull out the tube 2 from the case 16.

In another embodiment (not shown) of this variant of the case is the cap formed as a part of the wall of the case. A perforated line (not seen) between this part of the wall of the case and the rest of the wall of the case is allowing the user (not shown) to separate the cap from the case 16 for getting access to the flaps and thereby be able to pull out the tube of the case.

In a preferred embodiment of the invention the case can be made of a flexible plastic with a wall-thickness of between 30 and 60 μm and the tube be made of a plastic foil with a thickness of between 10 and 50 μm.

The length of tube can moreover be between 150 mm and 800 mm, preferable between 300 mm and 500 mm and the width of the flat-laid tube be between 50 mm and 750 mm, preferable between 150 mm and 400 mm.

The width of the case can furthermore be between 20 mm and 90 mm, preferable between 30 mm and 80 mm and the depth of the case can be between 15 mm and 75 mm, preferable between 30 and 60 mm.

### EXAMPLE

In an assembly consisting of a bag and a case for accommodating the folded bag was the bag made of polyester with a wall-thickness of 20 μm, a length of 450 mm and a width of 350 mm in flat-laid state, and the case was made of polyester with a wall-thickness of 50 μm and had a mainly rectangular shape with a depth of 50 mm, a width of 80 mm and a thickness of 4 mm.

1. An assembly of a recipient (2) and a retainer (2) formed as a case (3), the recipient (2) is for receiving objects of different kinds in a using state of the assembly (1), the retainer (3) has an access opening (5), and in a resting state of the assembly the retainer serves (1) for retaining the recipient (2), the recipient (2), before being assembled with the case (3), is formed as a flat-laid flexible tube (2), which has a first and second end part, and which flat-laid flexible tube (2) in the resting state of the assembly is folded up in a predetermined way in the case (3) into at least nearly parallel zigzag folds (9) and (11), which are placed close to and/or are abutting each other, characterized in, that the retainer is formed as a case (3) with an access opening (5) into a cavity which has an area defined by a depth extending into a direction perpendicular to the access opening (5) and a width extending into a direction perpendicular to the direction of the depth, whereby the tube (2) has a larger area than said cavity.

2. An assembly according to claim 1, characterized in that one of the folds (11) is attached to the case (3) while the other folds (11) freely are arranged in the case (3).

3. An assembly according to claim 1, or 2, characterized in that the second end part of the tube (2) is formed with a mouth (7) which is placed at the access opening (5) of the case (3) when the tube (2) is folded up in the case (3).

4. An assembly according to any of the claims 1-3, characterized in that the access opening (5) of the case (3) has a length, which is smaller than the width of the case (3).

5. An assembly according to any of the claims 1-4, characterized in that the second end part of the tube (2) is equipped with or is integral with at least one flap (4), which is protruding outwards of the access opening (5) of the case (3) when the tube (2) is folded up in the case (3).

6. An assembly according to any of the claims 1-4, characterized in that the second end part of the tube (2) is equipped with or is integral with at least one flap (4), which is present in the case in the resting state of the assembly when the tube (2) is folded up in the case while the access opening (5) of the case is covered by a cap (17).

7. An assembly according to any of the claims 1-6, characterized in that the tube (2) is folded, when being in a flat-laid state, along a first row of first folding lines (8), which are extending crosswise the end parts of the tube (2) and are defining a first row of parallel first folds (9) of which at least one has a width with about the same size as the width of the cavity of the case (3), and that the first row of first folds (9) is folded along a second row of second folding lines (11), which are extending crosswise the first folding lines (8) and are defining a second row of parallel second folds (11) of which at least one has a width with about the same size as the depth of the cavity in the case (3).

8. An assembly according to claim 47, characterized in that a first end fold (9) at each of the ends of the first row of first folds (9) is folded along a first folding line (8) only.

9. An assembly according to claim 8, characterized in that at least one of the first end folds (9) has another size and shape than the other first folds (9).

10. An assembly according to any of the claims 7-9, characterized in that a second end fold (11) at each of the ends of the second row of second folds (11) is folded along a second folding line (10) only.

11. An assembly according to claim 10, characterized in that at least one of the second end folds (11) has another size and shape than the other second folds (11).

12. An assembly according to claim 10 or 11, characterized in that a first one of the second end folds (11) is attached to the case (3) by means of e.g. welding or gluing when the tube (2) is folded up in the case (3) while the other second folds (11) freely is arranged in the case (3).

13. An assembly according to any of the claims 1-12, characterized in that the length of tube (2) is between 150 mm and 800 mm, preferable between 300 mm and 500 mm, and that the width of the flat-laid tube (2) is between 50 mm and 750 mm, preferable between 150 mm and 400 mm.

14. An assembly according to any of the claims 1-13, characterized in that the width of the case (3) is between 20 mm and 90 mm, preferable between 30 mm and 80 mm, and that the depth of the case (3) is between 15 mm and 75 mm, preferable between 30 and 60 mm.

15. An assembly according to any of the claims 1-14, characterized in that the number of first folds (9) is between 2 and 10, preferable between 3 and 5.

16. An assembly according to any of the claims 1-15, characterized in that the number of second folds (11) is between 2 and 20, preferable between 7 and 15.

17. An assembly according to any of the claims 1-16, characterized in that both of the end parts of the tube (2) are open, while all the sides of the case (3) are closed except at the access opening (5).

18. An assembly according to any of the claims 1-17, characterized in that the first end part of the tube (2) is closed, while the second end part is open.

19. An assembly according to any of the claims 1-18, characterized in that the tube (2) is made of a foil of plastic or of a fabric.

20. An assembly according to any of the claims 1-19, characterized in that the tube (2) is made of plastic or paper.

21. An assembly according to any of the claims 1-20, characterized in that the case (3) is made of plastic, paper, cardboard or metal.

22. A method for producing an assembly (1) according to claim 1-21 of a recipient (2) for in a using state of the assembly receiving objects of different kinds and of a retainer (3) that has an access opening (5) and in a resting state of the assembly serves for retaining the recipient (2), characterized in that the method comprises the steps of,
forming the recipient (2) as a tube (2) of a foldable material,
flat-laying the tube (2),
folding up the flat-laid tube (2) in a predetermined way into parallel folds (9,11), which are placed closed to each other or are abutting each other, and
placing the folded tube (2) in the retainer (3).

23. A method according to claim 22, characterized in that the method further comprises the steps of forming the retainer (3) as a case (3) with an access opening (5) into a cavity which has an area defined by a depth extending into a direction perpendicular to the access opening (5) and a width extending into a direction perpendicular to the direction of the depth.

24. A method according to claim 22 or 23, characterized in that the method further comprises the steps of folding the flat-laid tube (2) along a first row of first folding lines (8), which are extending crosswise the end parts of the tube (2) and are defining a first row of parallel first folds (9) of which at least one has a width with about the same size as the width of the cavity of the case (3), folding the first row of first folds (9) along a second row of second folding lines (10), which are extending crosswise the first folding lines (8) and are defining a second row of parallel second folds (11), and forming at least one of the second folds (11) with a width with about the same size as the depth of the cavity in the case (3).

25. A method according to claim 22, 23 or 24, characterized in that the method further comprises the step of welding or gluing one of the second folds to the case (3) and arranging the other folds freely in the case (3).

26. A method according to any of the claims 22-25, characterized in that the method further comprises the steps of forming the second end part of the tube (2) with a mouth and placing said mouth at the access opening of the case (3) when the tube (2) is folded up into the case (3).

27. A method according to any of the claims 22-26, characterized in that the method further comprises the steps of forming the tube (2) of a sheet of a flexible and foldable material, folding the sheet, and welding or gluing the longitudinal extending edges of the sheet together.

28. A method according to any of the claims 22-27, characterized in that the method further comprises the steps of forming the tube (2) of two sheets of a flexible and foldable material and welding or gluing the longitudinal extending edges of the sheets together.

29. A method according to any of the claims 22-28, characterized in that the method further comprises the steps of forming the tube (2) by extruding a hose of a flexible and foldable plastic and cutting the hose crosswise into pieces of the required length.

30. A use of the assembly according to claim 1-21 and/or of the method according to claim 22-29 for in a using state receiving objects of different kinds and in a resting state storing the assembly.

31. A use according to claim 30 for using the assembly as a bag.
